(19) United States
(12) Patent Application Publication
(10) Pub. No.: US 2019/0205018 A1
(43) Pub. Date: Jul. 4, 2019

(54) BUILDING MANAGEMENT SYSTEM WITH GRAFFITI ANNOTATIONS

(71) Applicant: Johnson Controls Technology Company, Milwaukee, WI (US)

(72) Inventor: Justin D. Eltoft, Pleasant Prairie, WI (US)

(73) Assignee: Johnson Controls Technology Company, Milwaukee, WI (US)

(21) Appl. No.: 15/858,603

(22) Filed: Dec. 29, 2017

(51) Int. Cl. G06F 3/0484; G05B 15/02; G06F 3/0482; G06F 17/24; G06T 11/60

(52) U.S. Cl. CPC G06F 3/04845; G05B 15/02; G06T 2200/24; G06F 17/241; G06T 11/60; G06F 3/0482

(57) ABSTRACT

A building management system includes building equipment that operate to generate equipment data and a system manager. The system manager is configured to generate a graphical user interface. The user interface includes a navigation pane configured to allow a user to navigate between a plurality of views of the equipment data and graffiti annotations associated with one or more of the plurality of views. The graffiti annotations include free-form marks input by a user using a graffiti editing toolbar.

### BACKGROUND

The present disclosure relates generally to a building management system (BMS), and more particularly to a BMS with a graphical user interface that allows users to monitor, control, and manage building equipment. A BMS is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof.

### SUMMARY

One implementation of the present disclosure is a building management system. The building management system includes building equipment that operate to generate equipment data and a system manager. The system manager is configured to generate a graphical user interface. The user interface includes a navigation pane configured to allow a user to navigate between a plurality of views of the equipment data and graffiti annotations associated with one or more of the plurality of views. The graffiti annotations include free-form marks input by a user using a graffiti editing toolbar.

In some embodiments, the system manager is configured to store the graffiti annotations in a graffiti layer. The graffiti layer includes a graffiti page for each of the plurality of views. In some embodiments, the graphical user interface includes an option to hide the graffiti layer. The system manager is further configured to remove the graffiti annotations from the graphical user interface in response to a user selection of the option to hide the graffiti layer.

In some embodiments, the graphical user interface includes an option to show a second graffiti layer comprising second graffiti annotations. The system manager is further configured to add the second graffiti annotations to the user interface in response to a user selection of the option to show the second graffiti layer.

In some embodiments, the graphical user interface is accessible by a first user and one or more other users and further comprises an option to set the graffiti layer as private to the first user. The system manager is configured to hide the graffiti layer from the one or more other users in response to a selection of the option to set the graffiti as private to the first user. In some embodiments, the graphical user interface also includes an option to share the graffiti layer with the first user and the one or more other users. The system manager is configured to allow the first user and the one or more other users to see the graffiti layer in response to a selection of the option to share the graffiti layer with the first user and the one or more other users.

In some embodiments, the graffiti editing toolbar comprises a pen tool configured to allow the user to add to the graffiti annotations on the graffiti layer. The graffiti annotations comprising free-form drawings made using the pen tool. In some embodiments, the pen tool is configured to create graffiti annotations in a plurality of colors. Each user of a plurality of users is assigned a different color and the graffiti annotations made by each user are displayed in the color assigned to the user.

In some embodiments, the graffiti editing toolbar comprises an eraser tool configured to allow the user to remove a portion of the graffiti annotations from the graffiti layer. In some embodiments, the graffiti editing toolbar comprises a stickers tool configured to allow the user to add a sticker to the graffiti annotations. The sticker includes at least one of a shape, an arrow, a character, or an emoji.

Another implementation of the present disclosure is a building management system. The building management system has building equipment that operate to generate equipment data and an interface generator generate a user interface that displays the equipment data. The user interface includes a graphical view of the equipment data and graffiti annotations mapped to the graphical view. The graffiti annotations include free-form marks input by a user.

In some embodiments, the graffiti annotations are stored in one or more graffiti layers. The one or more graffiti layers are selectively shown based on user input to a layers menu provided in the user interface. In some embodiments, the interface generator is configured to store each of the one or more graffiti layers as a private graffiti layer that is private to a first user or a shared graffiti layer that is shared with a plurality of users based on a layer sharing option provided in the user interface.

In some embodiments, the user interface includes graffiti editing toolbar configured to allow a user to add free-form marks to the graffiti layer.

Another implementation of the present disclosure is a method for managing building equipment in a building management system. The method includes operating the building equipment to generate equipment data and generating a graphical user interface having an equipment information layer comprising the equipment data. The method also includes associating a graffiti layer with the equipment information layer, allowing a first user of the graphical user interface to input free-form annotations to the graffiti layer, saving the free-form annotations to the graffiti layer, and overlaying the graffiti layer on top of the equipment information layer such that graphical user interface comprises the free-form annotations overlaid on top of the equipment data.

In some embodiments, the method also includes storing the graffiti layer in a database, receiving a request from a second user to display the equipment information layer, retrieving the graffiti layer from the database in response to the request, and overlaying the graffiti layer on top of the equipment information layer such that the second user is presented both the equipment data and the free-form annotations overlaid on top of the equipment data.

In some embodiments, the method also includes providing an option on the graphical user interface to hide the graffiti layer and hiding the free-form annotations in response to a selection of the option to hide the graffiti layer. In some embodiments, the graphical user interface comprises a plurality of pages, each of the pages comprising a different view of the equipment data. The method also includes associating a different graffiti layer with of the pages, each graffiti layer including free-form annotations.

In some embodiments, the equipment layer includes real-time information associated with the building equipment. The real-time information includes at least one of a current status, a current measurement, or an up-to-date metric. In some embodiments, the free-form annotations are hand-drawn annotations input by a user using a mouse or a touch-screen input.

### BRIEF DESCRIPTION OF THE DRAWINGS

FIG. 1 is a drawing of a building equipped with a HVAC system, according to some embodiments.

FIG. 2 is a block diagram of a waterside system which can be used to serve the building of FIG. 1, according to some embodiments.

FIG. 3 is a block diagram of an airside system which can be used to serve the building of FIG. 1, according to some embodiments.

FIG. 4 is a block diagram of a building management system (BMS) which can be used to monitor and control the building of FIG. 1, according to some embodiments.

FIG. 5 is a block diagram of another BMS which can be used to monitor and control the building of FIG. 1, according to some embodiments.

FIG. 6 is an illustration of a graphical user interface generated by the BMS of FIGS. 4-5, according to an exemplary embodiment.

FIG. 7 is an illustration of the graphical user interface of FIG. 6 with a graffiti layers module, according to an exemplary embodiment.

FIG. 8 is an illustration of the graphical user interface of FIG. 6 with a graffiti editing toolbar, according to an exemplary embodiment.

FIG. 9 is a flowchart of a process for generating the graphical user interfaces of FIGS. 6-8, according to an exemplary embodiment.

### DETAILED DESCRIPTION

### Building HVAC Systems and Building Management Systems

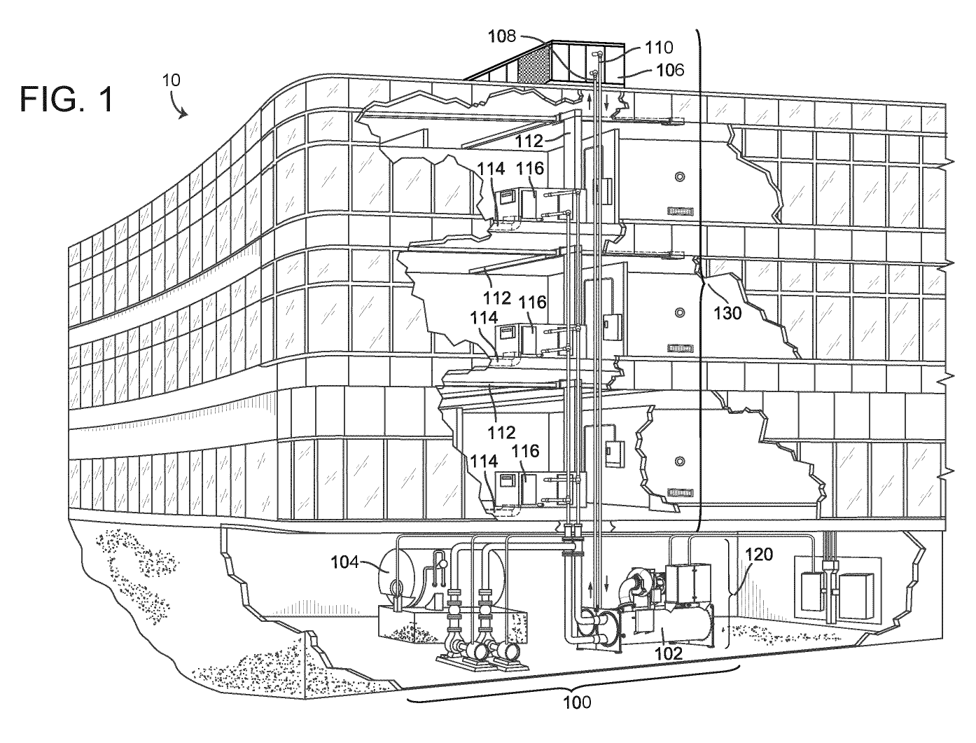

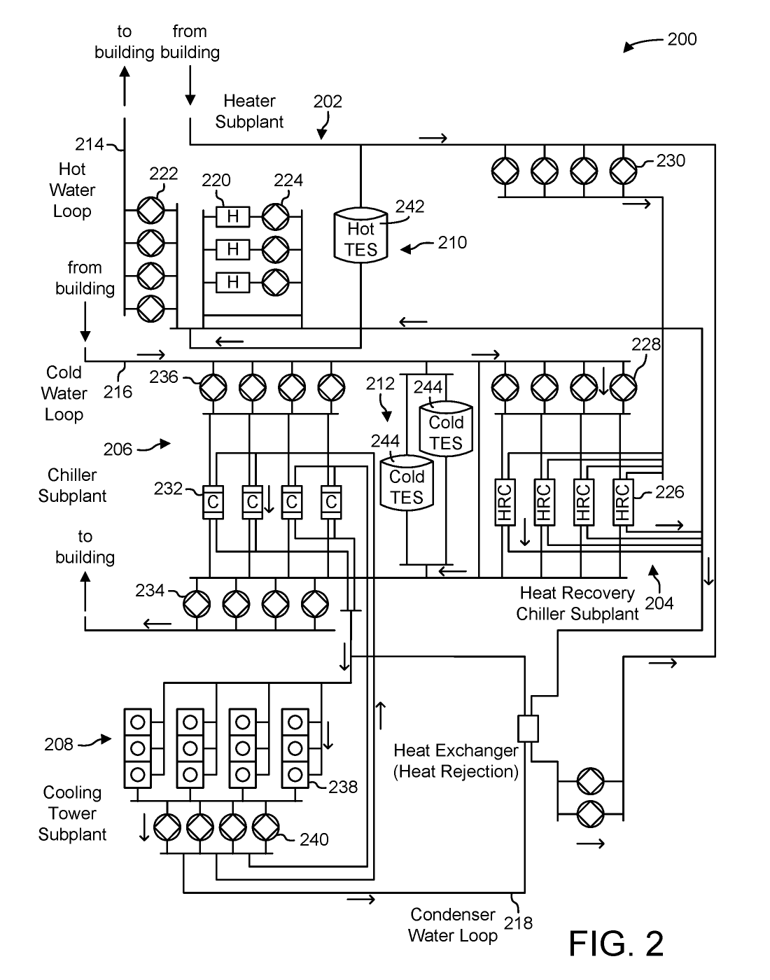

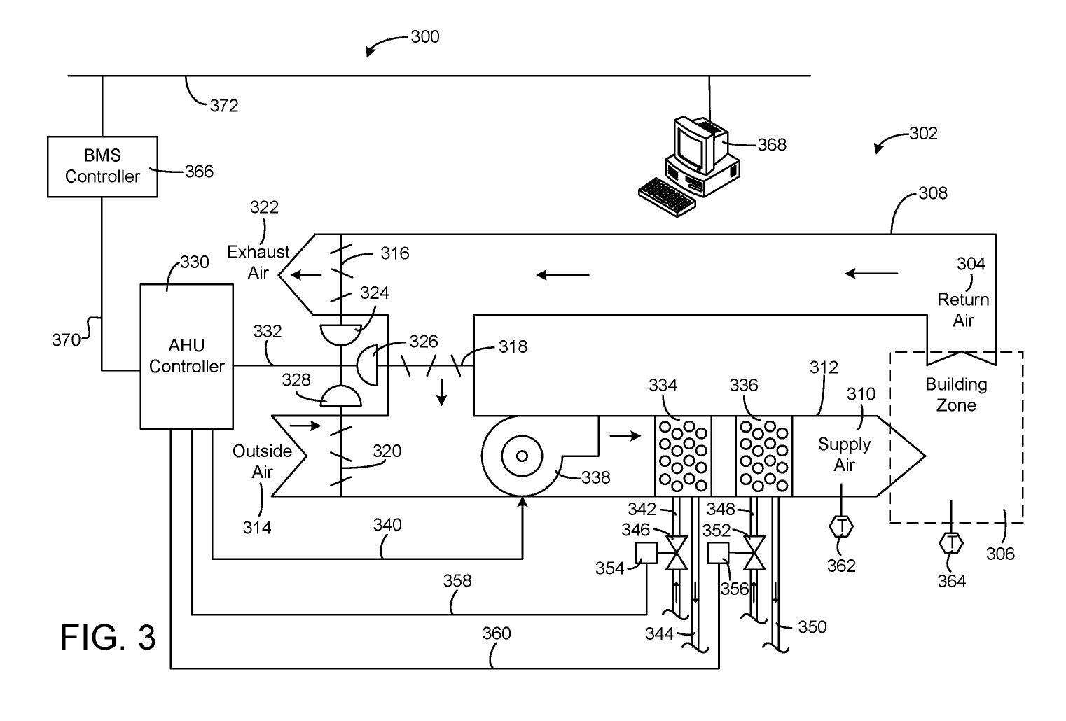

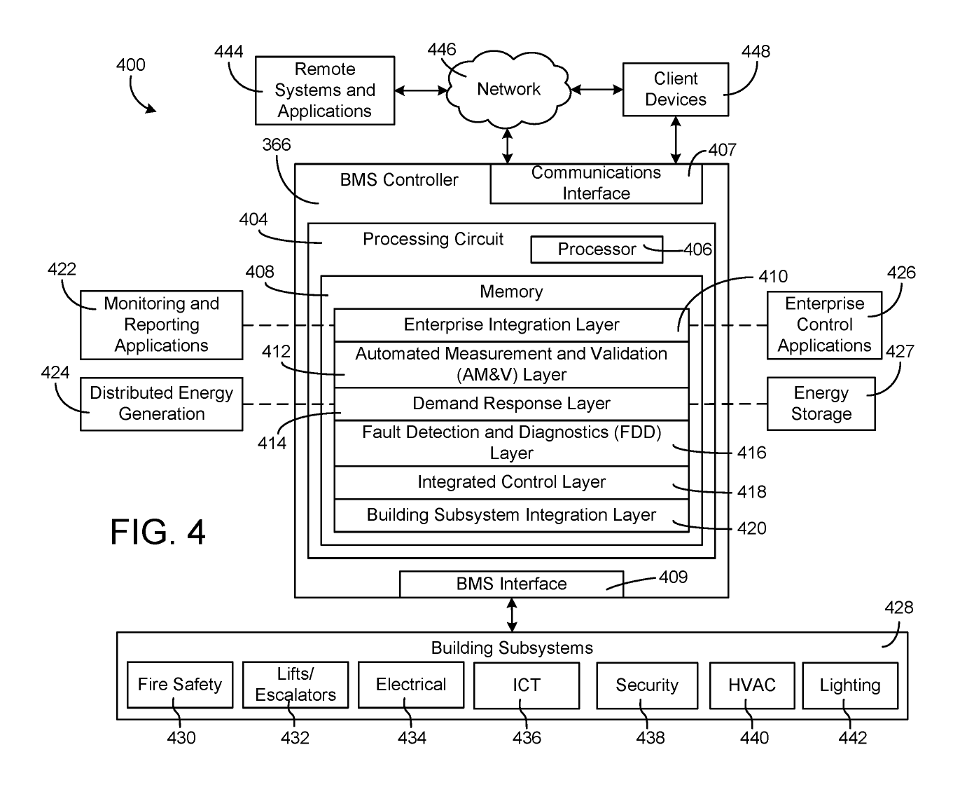

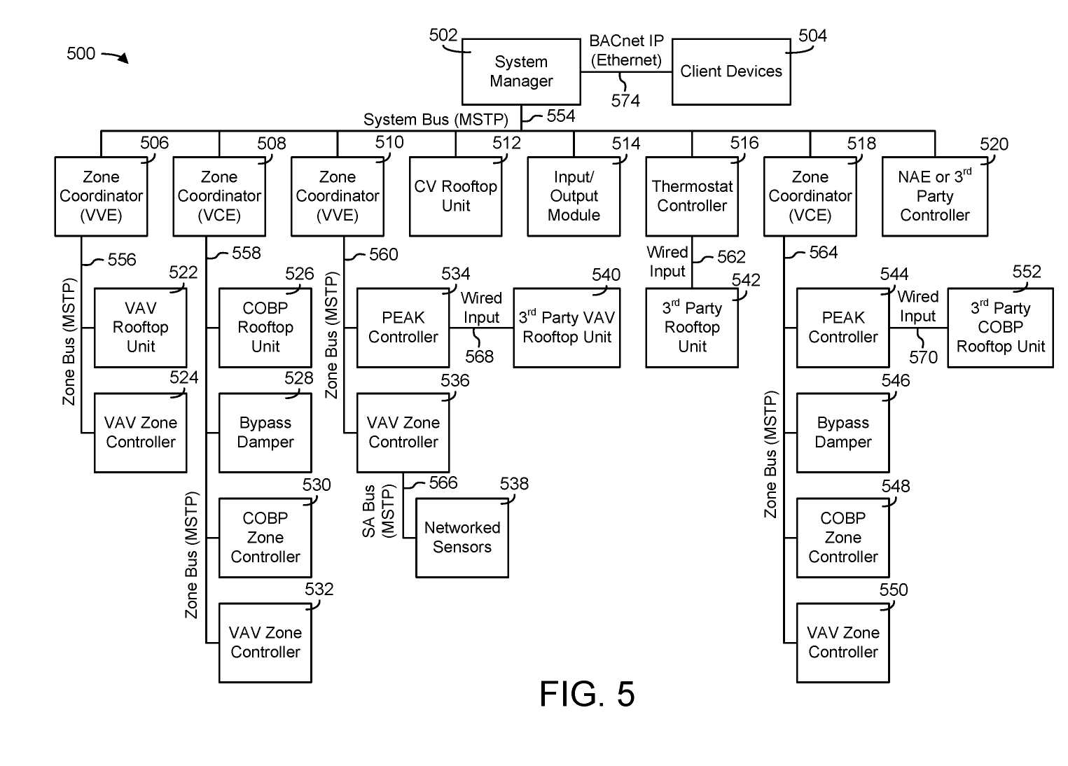

Referring now to FIGS. 1-5, several building management systems (BMS) and HVAC systems in which the systems and methods of the present disclosure can be implemented are shown, according to some embodiments. In brief overview, FIG. 1 shows a building 10 equipped with a HVAC system 100. FIG. 2 is a block diagram of a waterside system 200 which can be used to serve building 10. FIG. 3 is a block diagram of an airside system 300 which can be used to serve building 10. FIG. 4 is a block diagram of a BMS which can be used to monitor and control building 10. FIG. 5 is a block diagram of another BMS which can be used to monitor and control building 10.

### Building and HVAC System

Referring particularly to FIG. 1, a perspective view of a building 10 is shown. Building 10 is served by a BMS. A BMS is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof.

The BMS that serves building 10 includes a HVAC system 100. HVAC system 100 can include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 may provide a heated or chilled fluid to an air handling unit of airside system 130. Airside system 130 may use the heated or chilled fluid to heat or cool an airflow provided to building 10. An exemplary waterside system and airside system which can be used in HVAC system 100 are described in greater detail with reference to FIGS. 2-3.

HVAC system 100 is shown to include a chiller 102, a boiler 104, and a rooftop air handling unit (AHU) 106. Waterside system 120 may use boiler 104 and chiller 102 to heat or cool a working fluid (e.g., water, glycol, etc.) and may circulate the working fluid to AHU 106. In various embodiments, the HVAC devices of waterside system 120 can be located in or around building 10 (as shown in FIG. 1) or at an offsite location such as a central plant (e.g., a chiller plant, a steam plant, a heat plant, etc.). The working fluid can be heated in boiler 104 or cooled in chiller 102, depending on whether heating or cooling is required in building 10. Boiler 104 may add heat to the circulated fluid, for example, by burning a combustible material (e.g., natural gas) or using an electric heating element. Chiller 102 may place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 can be transported to AHU 106 via piping 108.

AHU 106 may place the working fluid in a heat exchange relationship with an airflow passing through AHU 106 (e.g., via one or more stages of cooling coils and/or heating coils). The airflow can be, for example, outside air, return air from within building 10, or a combination of both. AHU 106 may transfer heat between the airflow and the working fluid to provide heating or cooling for the airflow. For example, AHU 106 can include one or more fans or blowers configured to pass the airflow over or through a heat exchanger containing the working fluid. The working fluid may then return to chiller 102 or boiler 104 via piping 110.

Airside system 130 may deliver the airflow supplied by AHU 106 (i.e., the supply airflow) to building 10 via air supply ducts 112 and may provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 can include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 can include various sensors (e.g., temperature sensors, pressure sensors, etc.) configured to measure attributes of the supply airflow. AHU 106 may receive input from sensors located within AHU 106 and/or within the building zone and may adjust the flow rate, temperature, or other attributes of the supply airflow through AHU 106 to achieve setpoint conditions for the building zone.

### Waterside System

Referring now to FIG. 2, a block diagram of a waterside system 200 is shown, according to some embodiments. In various embodiments, waterside system 200 may supplement or replace waterside system 120 in HVAC system 100 or can be implemented separate from HVAC system 100. When implemented in HVAC system 100, waterside system 200 can include a subset of the HVAC devices in HVAC system 100 (e.g., boiler 104, chiller 102, pumps, valves, etc.) and may operate to supply a heated or chilled fluid to AHU 106. The HVAC devices of waterside system 200 can be located within building 10 (e.g., as components of waterside system 120) or at an offsite location such as a central plant.

In FIG. 2, waterside system 200 is shown as a central plant having a plurality of subplants 202-212. Subplants 202-212 are shown to include a heater subplant 202, a heat recovery chiller subplant 204, a chiller subplant 206, a cooling tower subplant 208, a hot thermal energy storage (TES) subplant 210, and a cold thermal energy storage (TES) subplant 212. Subplants 202-212 consume resources (e.g., water, natural gas, electricity, etc.) from utilities to serve thermal energy loads (e.g., hot water, cold water, heating, cooling, etc.) of a building or campus. For example, heater subplant 202 can be configured to heat water in a hot water loop 214 that circulates the hot water between heater subplant 202 and building 10. Chiller subplant 206 can be configured to chill water in a cold water loop 216 that circulates the cold water between chiller subplant 206 building 10. Heat recovery chiller subplant 204 can be configured to transfer heat from cold water loop 216 to hot water loop 214 to provide additional heating for the hot water and additional cooling for the cold water. Condenser water loop 218 may absorb heat from the cold water in chiller subplant 206 and reject the absorbed heat in cooling tower subplant 208 or transfer the absorbed heat to hot water loop 214. Hot TES subplant 210 and cold TES subplant 212 may store hot and cold thermal energy, respectively, for subsequent use.

Hot water loop 214 and cold water loop 216 may deliver the heated and/or chilled water to air handlers located on the rooftop of building 10 (e.g., AHU 106) or to individual floors or zones of building 10 (e.g., VAV units 116). The air handlers push air past heat exchangers (e.g., heating coils or cooling coils) through which the water flows to provide heating or cooling for the air. The heated or cooled air can be delivered to individual zones of building 10 to serve thermal energy loads of building 10. The water then returns to subplants 202-212 to receive further heating or cooling.

Although subplants 202-212 are shown and described as heating and cooling water for circulation to a building, it is understood that any other type of working fluid (e.g., glycol, CO2, etc.) can be used in place of or in addition to water to serve thermal energy loads. In other embodiments, subplants 202-212 may provide heating and/or cooling directly to the building or campus without requiring an intermediate heat transfer fluid. These and other variations to waterside system 200 are within the teachings of the present disclosure.

Each of subplants 202-212 can include a variety of equipment configured to facilitate the functions of the subplant. For example, heater subplant 202 is shown to include a plurality of heating elements 220 (e.g., boilers, electric heaters, etc.) configured to add heat to the hot water in hot water loop 214. Heater subplant 202 is also shown to include several pumps 222 and 224 configured to circulate the hot water in hot water loop 214 and to control the flow rate of the hot water through individual heating elements 220. Chiller subplant 206 is shown to include a plurality of chillers 232 configured to remove heat from the cold water in cold water loop 216. Chiller subplant 206 is also shown to include several pumps 234 and 236 configured to circulate the cold water in cold water loop 216 and to control the flow rate of the cold water through individual chillers 232.

Heat recovery chiller subplant 204 is shown to include a plurality of heat recovery heat exchangers 226 (e.g., refrigeration circuits) configured to transfer heat from cold water loop 216 to hot water loop 214. Heat recovery chiller subplant 204 is also shown to include several pumps 228 and 230 configured to circulate the hot water and/or cold water through heat recovery heat exchangers 226 and to control the flow rate of the water through individual heat recovery heat exchangers 226. Cooling tower subplant 208 is shown to include a plurality of cooling towers 238 configured to remove heat from the condenser water in condenser water loop 218. Cooling tower subplant 208 is also shown to include several pumps 240 configured to circulate the condenser water in condenser water loop 218 and to control the flow rate of the condenser water through individual cooling towers 238.

Hot TES subplant 210 is shown to include a hot TES tank 242 configured to store the hot water for later use. Hot TES subplant 210 may also include one or more pumps or valves configured to control the flow rate of the hot water into or out of hot TES tank 242. Cold TES subplant 212 is shown to include cold TES tanks 244 configured to store the cold water for later use. Cold TES subplant 212 may also include one or more pumps or valves configured to control the flow rate of the cold water into or out of cold TES tanks 244.

In some embodiments, one or more of the pumps in waterside system 200 (e.g., pumps 222, 224, 228, 230, 234, 236, and/or 240) or pipelines in waterside system 200 include an isolation valve associated therewith. Isolation valves can be integrated with the pumps or positioned upstream or downstream of the pumps to control the fluid flows in waterside system 200. In various embodiments, waterside system 200 can include more, fewer, or different types of devices and/or subplants based on the particular configuration of waterside system 200 and the types of loads served by waterside system 200.

### Airside System

Referring now to FIG. 3, a block diagram of an airside system 300 is shown, according to some embodiments. In various embodiments, airside system 300 may supplement or replace airside system 130 in HVAC system 100 or can be implemented separate from HVAC system 100. When implemented in HVAC system 100, airside system 300 can include a subset of the HVAC devices in HVAC system 100 (e.g., AHU 106, VAV units 116, ducts 112-114, fans, dampers, etc.) and can be located in or around building 10. Airside system 300 may operate to heat or cool an airflow provided to building 10 using a heated or chilled fluid provided by waterside system 200.

In FIG. 3, airside system 300 is shown to include an economizer-type air handling unit (AHU) 302. Economizer-type AHUs vary the amount of outside air and return air used by the air handling unit for heating or cooling. For example, AHU 302 may receive return air 304 from building zone 306 via return air duct 308 and may deliver supply air 310 to building zone 306 via supply air duct 312. In some embodiments, AHU 302 is a rooftop unit located on the roof of building 10 (e.g., AHU 106 as shown in FIG. 1) or otherwise positioned to receive both return air 304 and outside air 314. AHU 302 can be configured to operate exhaust air damper 316, mixing damper 318, and outside air damper 320 to control an amount of outside air 314 and return air 304 that combine to form supply air 310. Any return air 304 that does not pass through mixing damper 318 can be exhausted from AHU 302 through exhaust damper 316 as exhaust air 322.

Each of dampers 316-320 can be operated by an actuator. For example, exhaust air damper 316 can be operated by actuator 324, mixing damper 318 can be operated by actuator 326, and outside air damper 320 can be operated by actuator 328. Actuators 324-328 may communicate with an AHU controller 330 via a communications link 332. Actuators 324-328 may receive control signals from AHU controller 330 and may provide feedback signals to AHU controller 330. Feedback signals can include, for example, an indication of a current actuator or damper position, an amount of torque or force exerted by the actuator, diagnostic information (e.g., results of diagnostic tests performed by actuators 324-328), status information, commissioning information, configuration settings, calibration data, and/or other types of information or data that can be collected, stored, or used by actuators 324-328. AHU controller 330 can be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control actuators 324-328.

Still referring to FIG. 3, AHU 302 is shown to include a cooling coil 334, a heating coil 336, and a fan 338 positioned within supply air duct 312. Fan 338 can be configured to force supply air 310 through cooling coil 334 and/or heating coil 336 and provide supply air 310 to building zone 306. AHU controller 330 may communicate with fan 338 via communications link 340 to control a flow rate of supply air 310. In some embodiments, AHU controller 330 controls an amount of heating or cooling applied to supply air 310 by modulating a speed of fan 338.

Cooling coil 334 may receive a chilled fluid from waterside system 200 (e.g., from cold water loop 216) via piping 342 and may return the chilled fluid to waterside system 200 via piping 344. Valve 346 can be positioned along piping 342 or piping 344 to control a flow rate of the chilled fluid through cooling coil 334. In some embodiments, cooling coil 334 includes multiple stages of cooling coils that can be independently activated and deactivated (e.g., by AHU controller 330, by BMS controller 366, etc.) to modulate an amount of cooling applied to supply air 310.

Heating coil 336 may receive a heated fluid from waterside system 200 (e.g., from hot water loop 214) via piping 348 and may return the heated fluid to waterside system 200 via piping 350. Valve 352 can be positioned along piping 348 or piping 350 to control a flow rate of the heated fluid through heating coil 336. In some embodiments, heating coil 336 includes multiple stages of heating coils that can be independently activated and deactivated (e.g., by AHU controller 330, by BMS controller 366, etc.) to modulate an amount of heating applied to supply air 310.

Each of valves 346 and 352 can be controlled by an actuator. For example, valve 346 can be controlled by actuator 354 and valve 352 can be controlled by actuator 356. Actuators 354-356 may communicate with AHU controller 330 via communications links 358-360. Actuators 354-356 may receive control signals from AHU controller 330 and may provide feedback signals to controller 330. In some embodiments, AHU controller 330 receives a measurement of the supply air temperature from a temperature sensor 362 positioned in supply air duct 312 (e.g., downstream of cooling coil 334 and/or heating coil 336). AHU controller 330 may also receive a measurement of the temperature of building zone 306 from a temperature sensor 364 located in building zone 306.

In some embodiments, AHU controller 330 operates valves 346 and 352 via actuators 354-356 to modulate an amount of heating or cooling provided to supply air 310 (e.g., to achieve a setpoint temperature for supply air 310 or to maintain the temperature of supply air 310 within a setpoint temperature range). The positions of valves 346 and 352 affect the amount of heating or cooling provided to supply air 310 by cooling coil 334 or heating coil 336 and may correlate with the amount of energy consumed to achieve a desired supply air temperature. AHU 330 may control the temperature of supply air 310 and/or building zone 306 by activating or deactivating coils 334-336, adjusting a speed of fan 338, or a combination of both.

Still referring to FIG. 3, airside system 300 is shown to include a building management system (BMS) controller 366 and a client device 368. BMS controller 366 can include one or more computer systems (e.g., servers, supervisory controllers, subsystem controllers, etc.) that serve as system level controllers, application or data servers, head nodes, or master controllers for airside system 300, waterside system 200, HVAC system 100, and/or other controllable systems that serve building 10. BMS controller 366 may communicate with multiple downstream building systems or subsystems (e.g., HVAC system 100, a security system, a lighting system, waterside system 200, etc.) via a communications link 370 according to like or disparate protocols (e.g., LON, BACnet, etc.). In various embodiments, AHU controller 330 and BMS controller 366 can be separate (as shown in FIG. 3) or integrated. In an integrated implementation, AHU controller 330 can be a software module configured for execution by a processor of BMS controller 366.

In some embodiments, AHU controller 330 receives information from BMS controller 366 (e.g., commands, setpoints, operating boundaries, etc.) and provides information to BMS controller 366 (e.g., temperature measurements, valve or actuator positions, operating statuses, diagnostics, etc.). For example, AHU controller 330 may provide BMS controller 366 with temperature measurements from temperature sensors 362-364, equipment on/off states, equipment operating capacities, and/or any other information that can be used by BMS controller 366 to monitor or control a variable state or condition within building zone 306.

Client device 368 can include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with HVAC system 100, its subsystems, and/or devices. Client device 368 can be a computer workstation, a client terminal, a remote or local interface, or any other type of user interface device. Client device 368 can be a stationary terminal or a mobile device. For example, client device 368 can be a desktop computer, a computer server with a user interface, a laptop computer, a tablet, a smartphone, a PDA, or any other type of mobile or non-mobile device. Client device 368 may communicate with BMS controller 366 and/or AHU controller 330 via communications link 372.

### Building Management Systems

Referring now to FIG. 4, a block diagram of a building management system (BMS) 400 is shown, according to some embodiments. BMS 400 can be implemented in building 10 to automatically monitor and control various building functions. BMS 400 is shown to include BMS controller 366 and a plurality of building subsystems 428. Building subsystems 428 are shown to include a building electrical subsystem 434, an information communication technology (ICT) subsystem 436, a security subsystem 438, a HVAC subsystem 440, a lighting subsystem 442, a lift/escalators subsystem 432, and a fire safety subsystem 430. In various embodiments, building subsystems 428 can include fewer, additional, or alternative subsystems. For example, building subsystems 428 may also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10. In some embodiments, building subsystems 428 include waterside system 200 and/or airside system 300, as described with reference to FIGS. 2-3.

Each of building subsystems 428 can include any number of devices, controllers, and connections for completing its individual functions and control activities. HVAC subsystem 440 can include many of the same components as HVAC system 100, as described with reference to FIGS. 1-3. For example, HVAC subsystem 440 can include a chiller, a boiler, any number of air handling units, economizers, field controllers, supervisory controllers, actuators, temperature sensors, and other devices for controlling the temperature, humidity, airflow, or other variable conditions within building 10. Lighting subsystem 442 can include any number of light fixtures, ballasts, lighting sensors, dimmers, or other devices configured to controllably adjust the amount of light provided to a building space. Security subsystem 438 can include occupancy sensors, video surveillance cameras, digital video recorders, video processing servers, intrusion detection devices, access control devices and servers, or other security-related devices.

Still referring to FIG. 4, BMS controller 366 is shown to include a communications interface 407 and a BMS interface 409. Interface 407 may facilitate communications between BMS controller 366 and external applications (e.g., monitoring and reporting applications 422, enterprise control applications 426, remote systems and applications 444, applications residing on client devices 448, etc.) for allowing user control, monitoring, and adjustment to BMS controller 366 and/or subsystems 428. Interface 407 may also facilitate communications between BMS controller 366 and client devices 448. BMS interface 409 may facilitate communications between BMS controller 366 and building subsystems 428 (e.g., HVAC, lighting security, lifts, power distribution, business, etc.).

Interfaces 407, 409 can be or include wired or wireless communications interfaces (e.g., jacks, antennas, transmitters, receivers, transceivers, wire terminals, etc.) for conducting data communications with building subsystems 428 or other external systems or devices. In various embodiments, communications via interfaces 407, 409 can be direct (e.g., local wired or wireless communications) or via a communications network 446 (e.g., a WAN, the Internet, a cellular network, etc.). For example, interfaces 407, 409 can include an Ethernet card and port for sending and receiving data via an Ethernet-based communications link or network. In another example, interfaces 407, 409 can include a Wi-Fi transceiver for communicating via a wireless communications network. In another example, one or both of interfaces 407, 409 can include cellular or mobile phone communications transceivers. In one embodiment, communications interface 407 is a power line communications interface and BMS interface 409 is an Ethernet interface. In other embodiments, both communications interface 407 and BMS interface 409 are Ethernet interfaces or are the same Ethernet interface.

Still referring to FIG. 4, BMS controller 366 is shown to include a processing circuit 404 including a processor 406 and memory 408. Processing circuit 404 can be communicably connected to BMS interface 409 and/or communications interface 407 such that processing circuit 404 and the various components thereof can send and receive data via interfaces 407, 409. Processor 406 can be implemented as a general purpose processor, an application specific integrated circuit (ASIC), one or more field programmable gate arrays (FPGAs), a group of processing components, or other suitable electronic processing components.

Memory 408 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 408 can be or include volatile memory or non-volatile memory. Memory 408 can include database components, object code components, script components, or any other type of information structure for supporting the various activities and information structures described in the present application. According to some embodiments, memory 408 is communicably connected to processor 406 via processing circuit 404 and includes computer code for executing (e.g., by processing circuit 404 and/or processor 406) one or more processes described herein.

In some embodiments, BMS controller 366 is implemented within a single computer (e.g., one server, one housing, etc.). In various other embodiments BMS controller 366 can be distributed across multiple servers or computers (e.g., that can exist in distributed locations). Further, while FIG. 4 shows applications 422 and 426 as existing outside of BMS controller 366, in some embodiments, applications 422 and 426 can be hosted within BMS controller 366 (e.g., within memory 408).

Still referring to FIG. 4, memory 408 is shown to include an enterprise integration layer 410, an automated measurement and validation (AM&V) layer 412, a demand response (DR) layer 414, a fault detection and diagnostics (FDD) layer 416, an integrated control layer 418, and a building subsystem integration later 420. Layers 410-420 can be configured to receive inputs from building subsystems 428 and other data sources, determine optimal control actions for building subsystems 428 based on the inputs, generate control signals based on the optimal control actions, and provide the generated control signals to building subsystems 428. The following paragraphs describe some of the general functions performed by each of layers 410-420 in BMS 400.

Enterprise integration layer 410 can be configured to serve clients or local applications with information and services to support a variety of enterprise-level applications. For example, enterprise control applications 426 can be configured to provide subsystem-spanning control to a graphical user interface (GUI) or to any number of enterprise-level business applications (e.g., accounting systems, user identification systems, etc.). Enterprise control applications 426 may also or alternatively be configured to provide configuration GUIs for configuring BMS controller 366. In yet other embodiments, enterprise control applications 426 can work with layers 410-420 to optimize building performance (e.g., efficiency, energy use, comfort, or safety) based on inputs received at interface 407 and/or BMS interface 409.

Building subsystem integration layer 420 can be configured to manage communications between BMS controller 366 and building subsystems 428. For example, building subsystem integration layer 420 may receive sensor data and input signals from building subsystems 428 and provide output data and control signals to building subsystems 428. Building subsystem integration layer 420 may also be configured to manage communications between building subsystems 428. Building subsystem integration layer 420 translate communications (e.g., sensor data, input signals, output signals, etc.) across a plurality of multi-vendor/multi-protocol systems.

Demand response layer 414 can be configured to optimize resource usage (e.g., electricity use, natural gas use, water use, etc.) and/or the monetary cost of such resource usage in response to satisfy the demand of building 10. The optimization can be based on time-of-use prices, curtailment signals, energy availability, or other data received from utility providers, distributed energy generation systems 424, from energy storage 427 (e.g., hot TES 242, cold TES 244, etc.), or from other sources. Demand response layer 414 may receive inputs from other layers of BMS controller 366 (e.g., building subsystem integration layer 420, integrated control layer 418, etc.). The inputs received from other layers can include environmental or sensor inputs such as temperature, carbon dioxide levels, relative humidity levels, air quality sensor outputs, occupancy sensor outputs, room schedules, and the like. The inputs may also include inputs such as electrical use (e.g., expressed in kWh), thermal load measurements, pricing information, projected pricing, smoothed pricing, curtailment signals from utilities, and the like.

According to some embodiments, demand response layer 414 includes control logic for responding to the data and signals it receives. These responses can include communicating with the control algorithms in integrated control layer 418, changing control strategies, changing setpoints, or activating/deactivating building equipment or subsystems in a controlled manner. Demand response layer 414 may also include control logic configured to determine when to utilize stored energy. For example, demand response layer 414 may determine to begin using energy from energy storage 427 just prior to the beginning of a peak use hour.

In some embodiments, demand response layer 414 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 414 uses equipment models to determine an optimal set of control actions. The equipment models can include, for example, thermodynamic models describing the inputs, outputs, and/or functions performed by various sets of building equipment. Equipment models may represent collections of building equipment (e.g., subplants, chiller arrays, etc.) or individual devices (e.g., individual chillers, heaters, pumps, etc.).

Demand response layer 414 may further include or draw upon one or more demand response policy definitions (e.g., databases, XML files, etc.). The policy definitions can be edited or adjusted by a user (e.g., via a graphical user interface) so that the control actions initiated in response to demand inputs can be tailored for the user's application, desired comfort level, particular building equipment, or based on other concerns. For example, the demand response policy definitions can specify which equipment can be turned on or off in response to particular demand inputs, how long a system or piece of equipment should be turned off, what setpoints can be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 418 can be configured to use the data input or output of building subsystem integration layer 420 and/or demand response later 414 to make control decisions. Due to the subsystem integration provided by building subsystem integration layer 420, integrated control layer 418 can integrate control activities of the subsystems 428 such that the subsystems 428 behave as a single integrated supersystem. In some embodiments, integrated control layer 418 includes control logic that uses inputs and outputs from a plurality of building subsystems to provide greater comfort and energy savings relative to the comfort and energy savings that separate subsystems could provide alone. For example, integrated control layer 418 can be configured to use an input from a first subsystem to make an energy-saving control decision for a second subsystem. Results of these decisions can be communicated back to building subsystem integration layer 420.

Integrated control layer 418 is shown to be logically below demand response layer 414. Integrated control layer 418 can be configured to enhance the effectiveness of demand response layer 414 by enabling building subsystems 428 and their respective control loops to be controlled in coordination with demand response layer 414. This configuration may advantageously reduce disruptive demand response behavior relative to conventional systems. For example, integrated control layer 418 can be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 418 can be configured to provide feedback to demand response layer 414 so that demand response layer 414 checks that constraints (e.g., temperature, lighting levels, etc.) are properly maintained even while demanded load shedding is in progress. The constraints may also include setpoint or sensed boundaries relating to safety, equipment operating limits and performance, comfort, fire codes, electrical codes, energy codes, and the like. Integrated control layer 418 is also logically below fault detection and diagnostics layer 416 and automated measurement and validation layer 412. Integrated control layer 418 can be configured to provide calculated inputs (e.g., aggregations) to these higher levels based on outputs from more than one building subsystem.

Automated measurement and validation (AM&V) layer 412 can be configured to verify that control strategies commanded by integrated control layer 418 or demand response layer 414 are working properly (e.g., using data aggregated by AM&V layer 412, integrated control layer 418, building subsystem integration layer 420, FDD layer 416, or otherwise). The calculations made by AM&V layer 412 can be based on building system energy models and/or equipment models for individual BMS devices or subsystems. For example, AM&V layer 412 may compare a model-predicted output with an actual output from building subsystems 428 to determine an accuracy of the model.

Fault detection and diagnostics (FDD) layer 416 can be configured to provide on-going fault detection for building subsystems 428, building subsystem devices (i.e., building equipment), and control algorithms used by demand response layer 414 and integrated control layer 418. FDD layer 416 may receive data inputs from integrated control layer 418, directly from one or more building subsystems or devices, or from another data source. FDD layer 416 may automatically diagnose and respond to detected faults. The responses to detected or diagnosed faults can include providing an alert message to a user, a maintenance scheduling system, or a control algorithm configured to attempt to repair the fault or to work-around the fault.

FDD layer 416 can be configured to output a specific identification of the faulty component or cause of the fault (e.g., loose damper linkage) using detailed subsystem inputs available at building subsystem integration layer 420. In other exemplary embodiments, FDD layer 416 is configured to provide “fault” events to integrated control layer 418 which executes control strategies and policies in response to the received fault events. According to some embodiments, FDD layer 416 (or a policy executed by an integrated control engine or business rules engine) may shut-down systems or direct control activities around faulty devices or systems to reduce energy waste, extend equipment life, or assure proper control response.

FDD layer 416 can be configured to store or access a variety of different system data stores (or data points for live data). FDD layer 416 may use some content of the data stores to identify faults at the equipment level (e.g., specific chiller, specific AHU, specific terminal unit, etc.) and other content to identify faults at component or subsystem levels. For example, building subsystems 428 may generate temporal (i.e., time-series) data indicating the performance of BMS 400 and the various components thereof. The data generated by building subsystems 428 can include measured or calculated values that exhibit statistical characteristics and provide information about how the corresponding system or process (e.g., a temperature control process, a flow control process, etc.) is performing in terms of error from its setpoint. These processes can be examined by FDD layer 416 to expose when the system begins to degrade in performance and alert a user to repair the fault before it becomes more severe.

Referring now to FIG. 5, a block diagram of another building management system (BMS) 500 is shown, according to some embodiments. BMS 500 can be used to monitor and control the devices of HVAC system 100, waterside system 200, airside system 300, building subsystems 428, as well as other types of BMS devices (e.g., lighting equipment, security equipment, etc.) and/or HVAC equipment.

BMS 500 provides a system architecture that facilitates automatic equipment discovery and equipment model distribution. Equipment discovery can occur on multiple levels of BMS 500 across multiple different communications busses (e.g., a system bus 554, zone buses 556-560 and 564, sensor/actuator bus 566, etc.) and across multiple different communications protocols. In some embodiments, equipment discovery is accomplished using active node tables, which provide status information for devices connected to each communications bus. For example, each communications bus can be monitored for new devices by monitoring the corresponding active node table for new nodes. When a new device is detected, BMS 500 can begin interacting with the new device (e.g., sending control signals, using data from the device) without user interaction.

Some devices in BMS 500 present themselves to the network using equipment models. An equipment model defines equipment object attributes, view definitions, schedules, trends, and the associated BACnet value objects (e.g., analog value, binary value, multistate value, etc.) that are used for integration with other systems. Some devices in BMS 500 store their own equipment models. Other devices in BMS 500 have equipment models stored externally (e.g., within other devices). For example, a zone coordinator 508 can store the equipment model for a bypass damper 528. In some embodiments, zone coordinator 508 automatically creates the equipment model for bypass damper 528 or other devices on zone bus 558. Other zone coordinators can also create equipment models for devices connected to their zone busses. The equipment model for a device can be created automatically based on the types of data points exposed by the device on the zone bus, device type, and/or other device attributes. Several examples of automatic equipment discovery and equipment model distribution are discussed in greater detail below.

Still referring to FIG. 5, BMS 500 is shown to include a system manager 502; several zone coordinators 506, 508, 510 and 518; and several zone controllers 524, 530, 532, 536, 548, and 550. System manager 502 can monitor data points in BMS 500 and report monitored variables to various monitoring and/or control applications. System manager 502 can communicate with client devices 504 (e.g., user devices, desktop computers, laptop computers, mobile devices, etc.) via a data communications link 574 (e.g., BACnet IP, Ethernet, wired or wireless communications, etc.). System manager 502 can provide a user interface to client devices 504 via data communications link 574. The user interface may allow users to monitor and/or control BMS 500 via client devices 504.

In some embodiments, system manager 502 is connected with zone coordinators 506-510 and 518 via a system bus 554. System manager 502 can be configured to communicate with zone coordinators 506-510 and 518 via system bus 554 using a master-slave token passing (MSTP) protocol or any other communications protocol. System bus 554 can also connect system manager 502 with other devices such as a constant volume (CV) rooftop unit (RTU) 512, an input/output module (IOM) 514, a thermostat controller 516 (e.g., a TEC5000 series thermostat controller), and a network automation engine (NAE) or third-party controller 520. RTU 512 can be configured to communicate directly with system manager 502 and can be connected directly to system bus 554. Other RTUs can communicate with system manager 502 via an intermediate device. For example, a wired input 562 can connect a third-party RTU 542 to thermostat controller 516, which connects to system bus 554.

System manager 502 can provide a user interface for any device containing an equipment model. Devices such as zone coordinators 506-510 and 518 and thermostat controller 516 can provide their equipment models to system manager 502 via system bus 554. In some embodiments, system manager 502 automatically creates equipment models for connected devices that do not contain an equipment model (e.g., IOM 514, third party controller 520, etc.). For example, system manager 502 can create an equipment model for any device that responds to a device tree request. The equipment models created by system manager 502 can be stored within system manager 502. System manager 502 can then provide a user interface for devices that do not contain their own equipment models using the equipment models created by system manager 502. In some embodiments, system manager 502 stores a view definition for each type of equipment connected via system bus 554 and uses the stored view definition to generate a user interface for the equipment.

Each zone coordinator 506-510 and 518 can be connected with one or more of zone controllers 524, 530-532, 536, and 548-550 via zone buses 556, 558, 560, and 564. Zone coordinators 506-510 and 518 can communicate with zone controllers 524, 530-532, 536, and 548-550 via zone busses 556-560 and 564 using a MSTP protocol or any other communications protocol. Zone busses 556-560 and 564 can also connect zone coordinators 506-510 and 518 with other types of devices such as variable air volume (VAV) RTUs 522 and 540, changeover bypass (COBP) RTUs 526 and 552, bypass dampers 528 and 546, and PEAK controllers 534 and 544.

Zone coordinators 506-510 and 518 can be configured to monitor and command various zoning systems. In some embodiments, each zone coordinator 506-510 and 518 monitors and commands a separate zoning system and is connected to the zoning system via a separate zone bus. For example, zone coordinator 506 can be connected to VAV RTU 522 and zone controller 524 via zone bus 556. Zone coordinator 508 can be connected to COBP RTU 526, bypass damper 528, COBP zone controller 530, and VAV zone controller 532 via zone bus 558. Zone coordinator 510 can be connected to PEAK controller 534 and VAV zone controller 536 via zone bus 560. Zone coordinator 518 can be connected to PEAK controller 544, bypass damper 546, COBP zone controller 548, and VAV zone controller 550 via zone bus 564.

A single model of zone coordinator 506-510 and 518 can be configured to handle multiple different types of zoning systems (e.g., a VAV zoning system, a COBP zoning system, etc.). Each zoning system can include a RTU, one or more zone controllers, and/or a bypass damper. For example, zone coordinators 506 and 510 are shown as Verasys VAV engines (VVEs) connected to VAV RTUs 522 and 540, respectively. Zone coordinator 506 is connected directly to VAV RTU 522 via zone bus 556, whereas zone coordinator 510 is connected to a third-party VAV RTU 540 via a wired input 568 provided to PEAK controller 534. Zone coordinators 508 and 518 are shown as Verasys COBP engines (VCEs) connected to COBP RTUs 526 and 552, respectively. Zone coordinator 508 is connected directly to COBP RTU 526 via zone bus 558, whereas zone coordinator 518 is connected to a third-party COBP RTU 552 via a wired input 570 provided to PEAK controller 544.

Zone controllers 524, 530-532, 536, and 548-550 can communicate with individual BMS devices (e.g., sensors, actuators, etc.) via sensor/actuator (SA) busses. For example, VAV zone controller 536 is shown connected to networked sensors 538 via SA bus 566. Zone controller 536 can communicate with networked sensors 538 using a MSTP protocol or any other communications protocol. Although only one SA bus 566 is shown in FIG. 5, it should be understood that each zone controller 524, 530-532, 536, and 548-550 can be connected to a different SA bus. Each SA bus can connect a zone controller with various sensors (e.g., temperature sensors, humidity sensors, pressure sensors, light sensors, occupancy sensors, etc.), actuators (e.g., damper actuators, valve actuators, etc.) and/or other types of controllable equipment (e.g., chillers, heaters, fans, pumps, etc.).

Each zone controller 524, 530-532, 536, and 548-550 can be configured to monitor and control a different building zone. Zone controllers 524, 530-532, 536, and 548-550 can use the inputs and outputs provided via their SA busses to monitor and control various building zones. For example, a zone controller 536 can use a temperature input received from networked sensors 538 via SA bus 566 (e.g., a measured temperature of a building zone) as feedback in a temperature control algorithm. Zone controllers 524, 530-532, 536, and 548-550 can use various types of control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control a variable state or condition (e.g., temperature, humidity, airflow, lighting, etc.) in or around building 10.

BMS User Interface with Graffiti Annotations

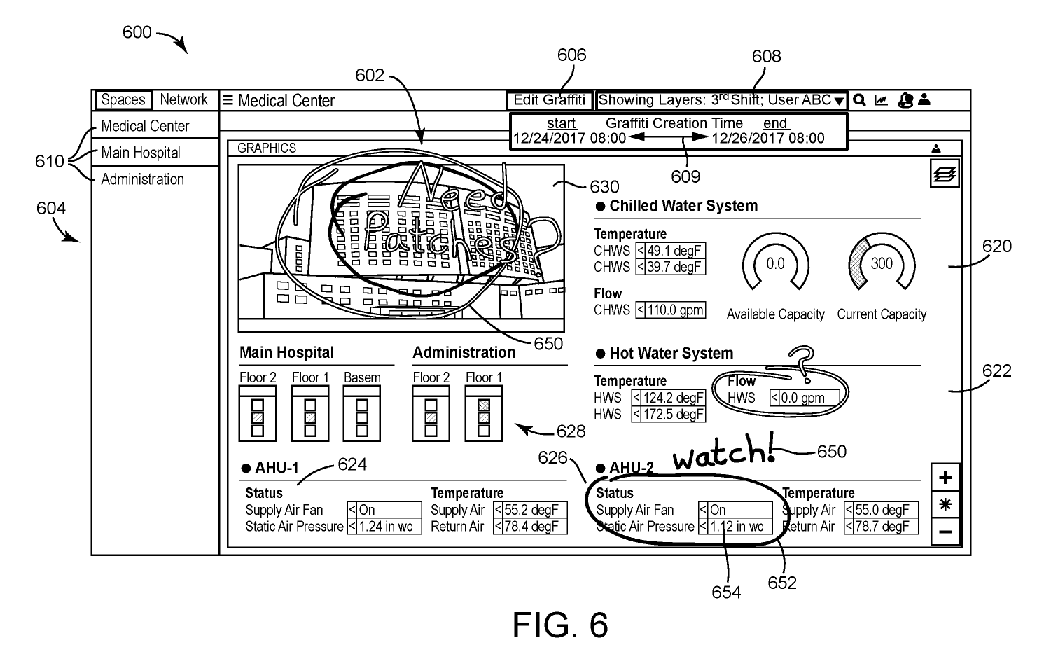

Referring now to FIGS. 6-8, several drawings illustrating a graphical user interface for controlling, monitoring, and managing a BMS are shown, according to an exemplary embodiment. The graphical user interface described below may be generated by any of the building management systems described with reference to FIGS. 1-5, and may be configured to accept user input to control, monitor, or manage any of the features or functions described with reference to FIGS. 1-5. For example, with reference to BMS 500 shown in FIG. 5, the graphical user interface may be generated by system manager 502 and transmitted to client devices 504 shown in FIG. 5. As described in detail below, users of the BMS (e.g., BMS 400, BMS 500), can then monitor, manage, and control the BMS using the graphical user interface presented on personal electronic devices (e.g., smartphones, tablets, laptops, desktop computers), such as client devices 504.

FIG. 6 shows a BMS user interface 600. In general, the BMS user interface 600 is configured to present status information and other metrics related to building equipment, spaces, and buildings managed by the BMS and provide options for controlling or managing the building equipment. As shown in FIG. 6, the BMS user interface 600 includes a graphics view 602, a navigation pane 604, an edit graffiti button 606, a layers menu 608, and a graffiti creation time box 609.

The navigation pane 604 is configured to allow a user to navigate to a variety of views in the BMS user interface 600. The navigation pane 604 includes several links 610, each of which corresponds to one of the variety of views in the BMS user interface 600. Each link 610 may contain the name of a building or space that is detailed in the corresponding view, and may be selected (e.g., clicked, touched) by a user to cause the BMS user interface 600 to show the corresponding view. Selecting the link “Medical Center”, for example, causes the BMS user interface 600 to show the graphics view 602 for “Medical Center” as in FIG. 6. The navigation pane 604 may be organized hierarchically, so that relationship between buildings within a facility or spaces within a building are clear from the arrangement of links 610 on the navigation pane 604.

The graphics view 602 contains a series of graphics configured to provide an overview of facility, building, space, and/or equipment status, data, measurements, and metrics stored in an equipment information layer of the graphics view 602. For example, graphics view 602 contains a chilled water system widget 620 and a hot water system widget 622 which show temperature and flow metrics for those systems. Graphics view 602 also includes an air handling unit 1 widget 624 and an air handling unit 2 widget 626, which shows status and temperature data for the corresponding air handling units. Graphics view 602 also includes floor status indicators 628 that show a status of subspaces of the “Medical Center,” and an image 630 of the “Medical Center.” According to various embodiments, the equipment information layer of graphics view 602 can include any combination of relevant images, graphics, charts, graphs, data, visualizations, input fields, toggles, options, or other user interface components suitable for providing real-time information and management options to a user regarding facilities, buildings, spaces, and equipment managed by the BMS.

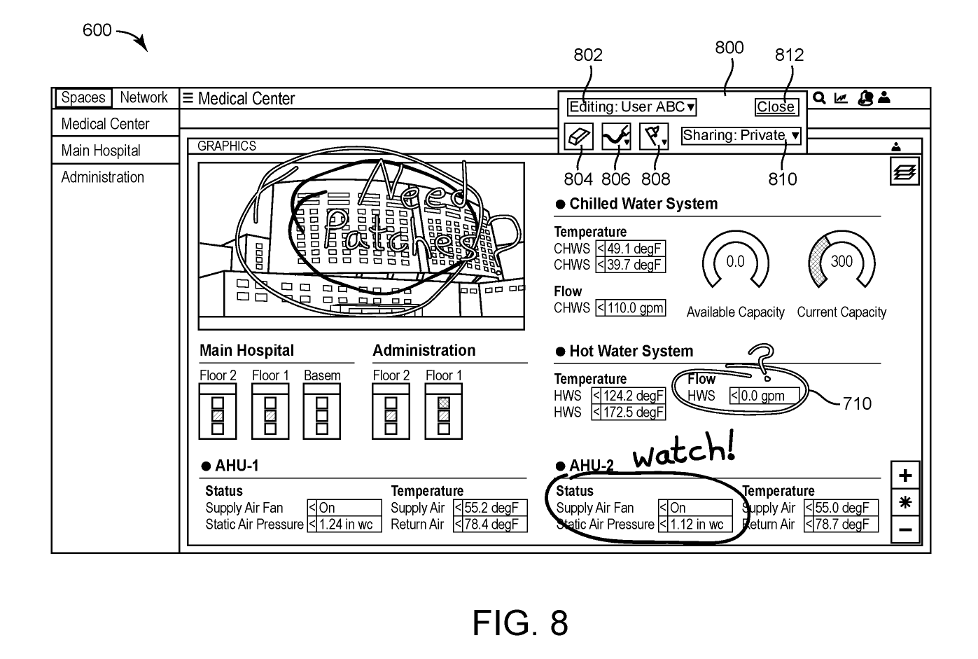

As shown in FIG. 6, graphics view 602 also includes graffiti 650. Graffiti 650 includes free-form annotations added to the graphics view 602 by a user. Graffiti 650 can be used to note a temporary warning, reminder, status, or other message for a single user (e.g., a note to one's self) or to be communicated between multiple users. Graffiti 650 can include shapes, characters, and other marks created by a user using a pen tool or other graffiti creation tool (e.g., using a finger on a touch screen of a mobile device, a mouse on a desktop computer, etc.), which can be accessed by selecting (e.g., clicking, tapping, touching, entering a keyboard shortcut) the edit graffiti button 606. The creation and editing of graffiti 650 is described in detail below with reference to FIG. 8.

In the BMS user interface 600, graffiti 650 is associated with the graphics view 602 such that graffiti 650 is fixed relative to the graphics view 602. For example, the graffiti 650 in FIG. 6 includes a ring 652 positioned surrounding a status indicator 654 in air handling unit 2 widget 626. Objects in the graphics view 602 can be selected (clicked, touched, etc.) through the graffiti, to interact with the equipment information layer of the graphics view 602 as if the graffiti was not present. If a user scrolls, zooms, rotates, or otherwise changes the user's perspective of graphics view 602, the ring 652 stays in position surrounding the status indicator 654. Furthermore, if the user navigates to a second view using navigation pane 604, the ring 652 is not visible in the second view, instead remaining surrounding status indicator 654 to be shown when the user navigates back to graphics view 602. The second view may include its own graffiti corresponding to the building management graphics shown in the second view. Thus, graffiti 650 is mapped to the graphics view 602, rather than to a fixed position on the screen or display independent of the BMS user interface 600. Advantageously, this allows graffiti 650 to ‘stick’ to metrics, graphics, or other information presented on the BMS user interface 600 to draw attention to or otherwise note something about the metrics, graphics, or information.

Graffiti creation time box 609 allows a user to select a timeline for which graffiti created in that time period is shown. When each mark of graffiti 650 is created (as described in detail below) the mark is stored by the BMS with a time stamp defined by the time when the mark was created, as well as other information such as the name of the user who created the mark. A user can selectively display graffiti for a user-defined time period (i.e., marks of graffiti with time stamps corresponding to times within the user-defined time period) by selecting the user-defined time period in graffiti creation time box 609. Selecting elements of graffiti time box 110 may open a date picker or sliding-timeline time selector and/or allow character-based entry of a date and time into a date and time entry field. The BMS then identifies a set of graffiti marks created during the selected time period and displays only the graffiti marks with stamps from that time period on the BMS user interface 600.

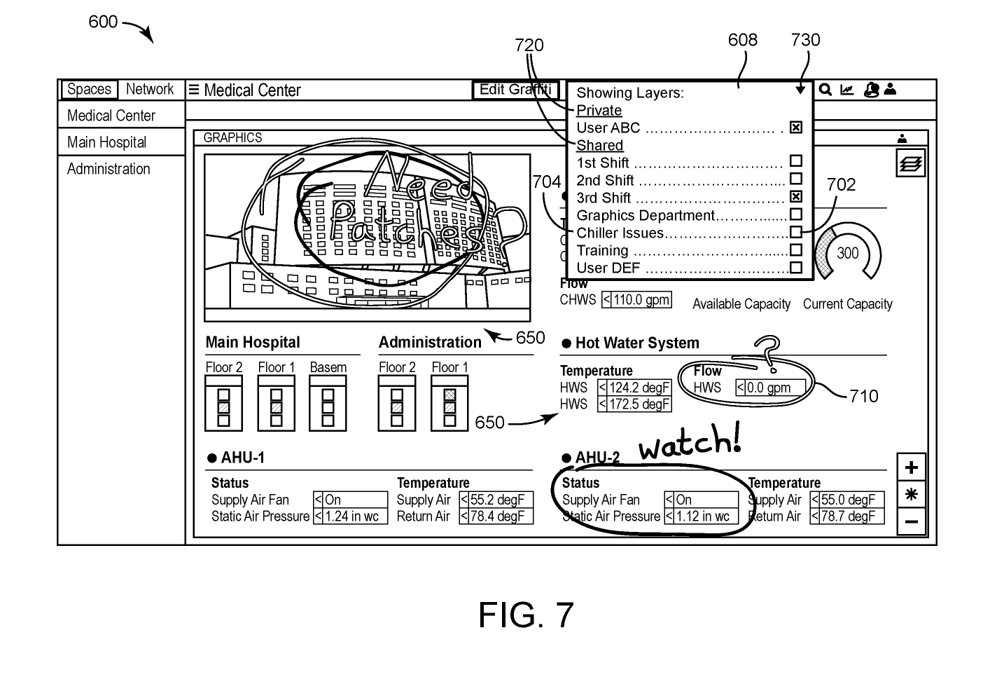

Graffiti 650 is stored in one or more layers in the BMS user interface 600, each layer covering all views available via the navigation pane 604. That is, each layer includes a separate page corresponding to each view available via the navigation pane 604. Layers allow for multiple categories of graffiti to be selectively shown on the BMS user interface 600. For example, a layer of graffiti may be associated with a user, a group of users (e.g., a shift, a department), a task, an equipment category, a subspace, or any other useful category. As described in detail below with reference to FIG. 7, layers menu 608 allows a user to select which layers of graffiti are displayed in the BMS user interface 600. Layers of graffiti can be selectively shown and hidden globally (i.e., all pages for a layer are set to be shown/hidden so that the setting applies to each view).

Referring now to FIG. 7, the BMS user interface 600 is shown with the layers menu 608 in an expanded form. The layers menu 608 is configured to expand from the compressed form of the layers menu 608 shown in FIG. 6 when a user selects the layers menu 608. As shown in FIG. 7, the layers menu 608 is configured to allow a user to select which layers are shown (and, if not selected, hidden) on the BMS user interface 600. A user may select to show a layer by selecting the checkbox 702 listed alongside the layer name 704. Layers may be arranged on the layers menu 608 in any organization, include alphabetically, randomly, by popularity, or by most recent use. In some embodiments, layers menu 608 includes a search feature to help a user find a desired layer. Layers menu 608 is used to show or hide graffiti layers globally, i.e., for all views accessible via navigation pane 604.

As shown in FIG. 7, layer “User ABC” and layer “3rd Shift” are selected in the layers menu 608, and are shown on the graphics view 602. For example, layer “User ABC” includes notation 710 that emphasizes the hot water system widget 622, while the layer “3rd Shift” includes notation 712 that calls attention to the image 630. Both layers are shown simultaneously on the graphics view 602. To hide the notation 710, for example, a user could deselect the check box 702 corresponding to the layer “User ABC.” In some embodiments, an indication of a layer name, a user who created the graffiti, and/or a time of graffiti creation can be seen by hovering a cursor over the graffiti 650 or otherwise selecting the graffiti 650, which may facilitate user selection of desired layers.

Layers menu 608 includes sharing status headers 720. The sharing status headers 720 indicate that a layer can be private (i.e., available only to the current user) or shared (i.e., available to a group of users or to all users). A private layer, for example layer “User ABC”, also as user (e.g., User ABC) to make notes, leave reminders, and flag important content for his or her own benefit. A private layer prevents a single user from cluttering the view of others or undesirably revealing embarrassing notes to other users. A shared layer, for example layer “3rd Shift”, allows multiple users to share information that might be relevant to multiple users. For example, the layer “3rd Shift” might be used by users working at other times of day (e.g., during 1st or 2nd shift) to view graffiti left by users working during 3rd shift hours, or to leave notes, annotations, drawings, and other indications for the users working during 3rd shift. Other shared layers may be useful for a manager to leave messages to employees managed by the manager, for users to leave notes to a graphics department or software development department to drive improvement of the user interface, or for training or other purposes. The layers menu 608 can be collapsed back to the compressed form shown in FIG. 6 by selecting the collapse button 730.

Referring now to FIG. 8, the BMS user interface 600 of FIGS. 6 and 7 is shown with a graffiti editing toolbar 800, according to an exemplary embodiment. Graffiti editing toolbar 800 is launched in response to a user selection of edit graffiti button 606 shown in FIG. 6. Graffiti editing toolbar 800 is configured to provide tools for a user to use to create, erase, or edit graffiti 650. Graffiti editing toolbar includes a layer selection drop-down menu 802, an eraser button 804, a pen selection drop-down menu 806, a sticker selection drop-down menu 808, and a sharing selection drop-down menu 810. Although shown with buttons and drop down menus, graffiti editing toolbar 800 can include any combination of user-selectable options that provide the user with the tools and options described herein.

Layer selection drop-down menu 802 allows a user to choose which layer the user is editing. Clicking the layer selection drop-down menu 802 opens a list of available layers, similar to layers menu 608. In some embodiments, only one layer may be edited at a time, while in other embodiments multiple layers may be edited simultaneously. The BMS user interface 600 may show only the layer or layers selected for editing in layer selection drop-down menu 802, or may show all layers selected in layers menu 608. In some embodiments, the layer selection drop-down menu 802 also includes an option for the user to create a new layer. According to some arrangements, the user can edit any layer that the user can choose to see (i.e., via layers menu 608), while in other embodiments the user is only allowed to edit certain layers (e.g., layers created by the user, layers the user is authorized to edit by an administrator).

When eraser button 804 is selected by a user, the user is provided with an eraser tool that can be used to erase existing graffiti 650. For example, a user could click the eraser button 804 to access the eraser tool, and then drag the eraser tool over notation 710 to erase notation 710. In some embodiments, the eraser button 804 provides options to access eraser tools of different sizes or shapes and/or allows the user to delete all graffiti from a layer or page/view without manually erasing each mark.

Pen selection drop-down menu 806 allows the user to choose a pen tool from a variety of pen options. The variety of pen options include pen tools of different colors, sizes, shapes, transparencies (e.g., as in a highlighter), thicknesses, or other features. In some embodiments, particular layers or users are assigned a particular pen type or color. The selected pen option is then applied to a pen tool accessed by the user. The user can use the pen tool to mark new graffiti on the selected layer. For example, a user using a personal computer with a mouse to view the BMS user interface 600 may move a cursor to a desired starting location, hold down a mouse button, drag the cursor along a path to make a mark with the pen tool along that path, and release the mouse button to stop marking the path of the cursor. In another example, a user using a touch-screen laptop, tablet, smartphone, or other device to access the BMS user interface 600 may touch a finger or stylus to the screen where a graffiti mark is desired to be made on the BMS user interface 600, resulting in a mark at that point made by the pen tool. The finger or stylus can be dragged around on the touchscreen to draw lines, shapes, characters, symbols, or other indications using the pen tool selected with the pen selection drop-down menu 806.

Sticker selection drop-down menu 808 allows a user to select a sticker to place on the layer as part of the graffiti 650. Stickers available on the sticker selection drop-down menu 808 may include arrows, shapes (e.g., circles, boxes, triangles, stars, thought bubbles, clouds, flags), symbols (exclamation points, question marks, numbers, letters), emojis (e.g., angry faces, smiley faces, flames), or other relevant graphics and images. Stickers can be placed in a desired position on the layer (i.e., in a position corresponding to an element of the graphics view 602) by a user by selecting the sticker from the sticker selection drop-down menu 808 and then clicking, touching, or otherwise selecting a point on the BMS user interface 600. In some embodiments, stickers can then be dragged to new positions, resized, or rotated as desired by the user.

Sharing selection drop-down menu 810 allows a user to select a sharing option for the layer being edited (i.e., the layer selected in layer selection drop-down menu 802). Sharing selection drop-down menu 810 may be selected by a user to reveal sharing options for the layer, including a ‘private’ setting, a shared globally setting (i.e., so that the layer is shared with all users of the BMS user interface 600), and a limited group sharing option (i.e., so that the user can share the user interface with a select group of other users). The sharing selection drop-down menu 810 may include a feature for allowing a user to pick members of the limited group for the limited group sharing option. In some embodiments, the user can edit the sharing option of any layer. In other embodiments the user can only edit the sharing option for layers the user created, so that the user cannot make other users' public layers private.

Graffiti editing toolbar 800 thereby provides a user with tools to create or edit graffiti. As mentioned above, the created or edited graffiti is stored in association with the graphics view 602 to ensure that the graffiti stays in position relative to elements of the graphics view 602. With the graffiti editing toolbar 800 engaged, a user may still use navigation pane 604 to navigate to other views and create or edit graffiti for the other views. The graffiti editing toolbar 800 can be closed using close button 812 to return to the BMS user interface configuration shown in FIG. 6.

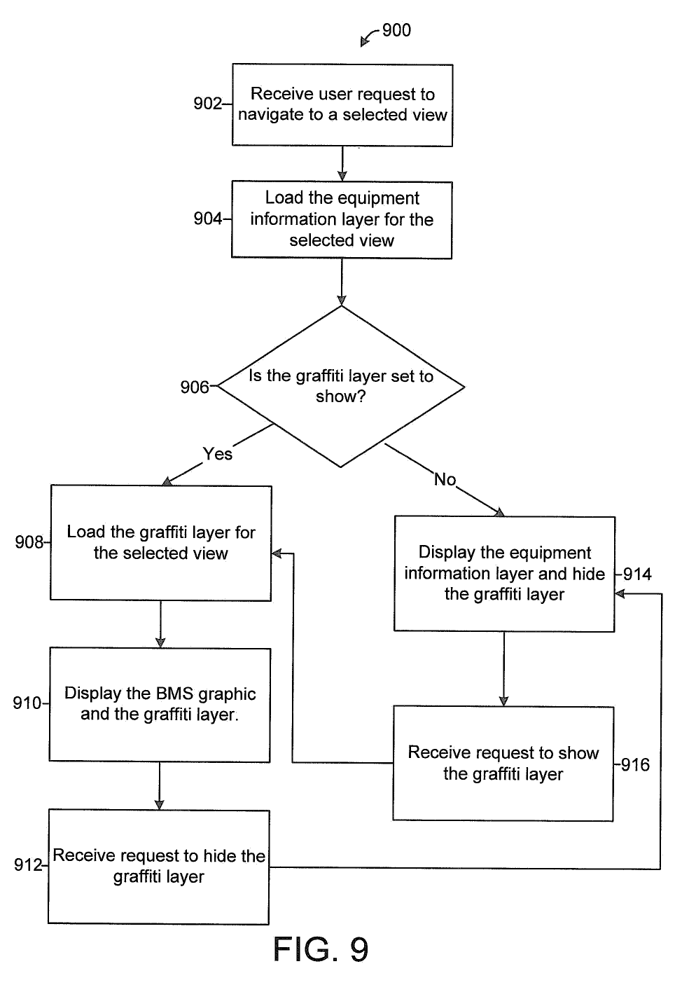

Referring now to FIG. 9, a flowchart of a process 900 for generating the user interfaces of FIGS. 6-7 is shown, according to an exemplary embodiment. Process 900 may be carried out by BMS 400 and BMS 500. More particularly, for example, process 900 may be carried out by system manager 502 of BMS 500 in communication with user devices 504, as shown in FIG. 5.

At step 902, the BMS receives a request from a user device to present a selected view, for example graphics view 602 as shown in FIG. 6. The request may be made by a user by selecting an entry on the navigation pane 604, or by entering a keyboard shortcut or some other form of input. In response to receiving the request to present the selected view, the BMS loads the equipment information layer for the selected view at step 904. As mentioned above, the equipment information layer may include any combination of images, graphics, charts, graphs, data, visualizations, input fields, toggles, options, or other user interface components suitable for providing information and management options to a user regarding buildings, spaces, and equipment managed by the BMS.

At step 906, the BMS determines whether a graffiti layer is set to show. This determination may be made by checking whether a user has selected to show the graffiti layer in the layers menu 608. In some cases, this determination also involves checking which of multiple possible graffiti layers are set to show, although for the sake of clarity a single graffiti layer is referred to in the description of process 900.

If the graffiti layer is set to show, the BMS loads the graffiti layer for the selected view at step 908. The graffiti layer is associated with the BMS graphics for the selected view such that the graffiti appears in its assigned positions relative to elements of the selected view overlaid on top of the equipment information layer. At step 910, the equipment information layer and the graffiti layer are presented on the BMS user interface transmitted to a user device. If the BMS later receives a request to hide the graffiti layer (e.g., via layers menu 608) at step 912, the BMS hides the graffiti layer and provides the equipment information layer to the user device without the graffiti layer at step 914.

If graffiti layer is not set to show (i.e., the graffiti layer is set to be hidden), the process 900 proceeds to step 914 where the equipment information layer is provided to the user device without the graffiti layer. If a request is later received to show the graffiti layer (e.g., via layers menu 608), the graffiti layer is loaded for the selected view at step 908 and the displayed overlaid on top of the equipment information layer at step 910. The graffiti layer may thus be selectively toggled on-and-off by a user.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A building management system comprising:
building equipment that operate to generate equipment data; and
a system manager configured to generate a graphical user interface comprising:
a navigation pane configured to allow a user to navigate between a plurality of views of the equipment data; and
graffiti annotations associated with one or more of the plurality of views, the graffiti annotations comprising free-form marks input by a user using a graffiti editing toolbar.

2. The building management system of claim 1, wherein the system manager is configured to store the graffiti annotations in a graffiti layer, the graffiti layer including a graffiti page for each of the plurality of views.

3. The building management system of claim 2, wherein the graphical user interface further comprises an option to hide the graffiti layer; and
wherein the system manager is further configured to remove the graffiti annotations from the graphical user interface in response to a user selection of the option to hide the graffiti layer.

4. The building management system of claim 2, wherein the graphical user interface further comprises an option to show a second graffiti layer comprising second graffiti annotations; and
wherein the system manager is further configured to add the second graffiti annotations to the user interface in response to a user selection of the option to show the second graffiti layer.

5. The building management system of claim 2, wherein the graphical user interface is accessible by a first user and one or more other users and further comprises an option to set the graffiti layer as private to the first user; and
wherein the system manager is configured to hide the graffiti layer from the one or more other users in response to a selection of the option to set the graffiti as private to the first user.

6. The building management system of claim 5, wherein graphical user interface further comprises an option to share the graffiti layer with the first user and the one or more other users; and
wherein the system manager is configured to allow the first user and the one or more other users to see the graffiti layer in response to a selection of the option to share the graffiti layer with the first user and the one or more other users.

7. The building management system of claim 2, wherein the graffiti editing toolbar comprises a pen tool configured to allow the user to add to the graffiti annotations on the graffiti layer, the graffiti annotations comprising free-form drawings made using the pen tool.

8. The building management system of claim 7, wherein the pen tool is configured to create graffiti annotations in a plurality of colors; and
wherein each user of a plurality of users is assigned a different color and the graffiti annotations made by each user are displayed in the color assigned to the user.

9. The building management system of claim 2, wherein the graffiti editing toolbar comprises an eraser tool configured to allow the user to remove a portion of the graffiti annotations from the graffiti layer.

10. The building management system of claim 2, wherein the graffiti editing toolbar comprises a stickers tool configured to allow the user to add a sticker to the graffiti annotations, the sticker comprising at least one of a shape, an arrow, a character, or an emoji.

11. A building management system comprising:
building equipment that operate to generate equipment data;
an interface generator configured to generate a user interface that displays the equipment data, the user interface comprising:
a graphical view of the equipment data; and
graffiti annotations mapped to the graphical view, the graffiti annotations comprising free-form marks input by a user.

12. The building management system of claim 11, wherein the graffiti annotations are stored in one or more graffiti layers; and
wherein the one or more graffiti layers are selectively shown based on user input to a layers menu provided in the user interface.

13. The building management system of claim 11, wherein the interface generator is configured to store each of the one or more graffiti layers as a private graffiti layer that is private to a first user or a shared graffiti layer that is shared with a plurality of users based on a layer sharing option provided in the user interface.

14. The building management system of claim 12, wherein the user interface comprises graffiti editing toolbar configured to allow a user to add free-form marks to the graffiti layer.

15. A method for managing building equipment in a building management system, the method comprising:
operating the building equipment to generate equipment data;
generating a graphical user interface having an equipment information layer comprising the equipment data;
associating a graffiti layer with the equipment information layer;
allowing a first user of the graphical user interface to input free-form annotations to the graffiti layer;
saving the free-form annotations to the graffiti layer; and
overlaying the graffiti layer on top of the equipment information layer such that graphical user interface comprises the free-form annotations overlaid on top of the equipment data.

16. The method of claim 15, further comprising:
storing the graffiti layer in a database;
receiving a request from a second user to display the equipment information layer;
retrieving the graffiti layer from the database in response to the request; and
overlaying the graffiti layer on top of the equipment information layer such that the second user is presented both the equipment data and the free-form annotations overlaid on top of the equipment data.

17. The method of claim 15, further comprising:
providing an option on the graphical user interface to hide the graffiti layer; and
hiding the free-form annotations in response to a selection of the option to hide the graffiti layer.

18. The method of claim 15, wherein the graphical user interface comprises a plurality of pages, each of the pages comprising a different view of the equipment data;
the method further comprising associating a different graffiti layer with each of the pages, each graffiti layer including free-form annotations.

19. The method of claim 15, wherein the equipment layer includes real-time information associated with the building equipment, wherein the real-time information comprises at least one of a current status, a current measurement, or an up-to-date metric.

20. The method of claim 15, wherein the free-form annotations are hand-drawn annotations input by a user using a mouse or touch-screen input.
